(19) United States
(12) Patent Application Publication
(10) Pub. No.: US 2025/0172770 A1
(43) Pub. Date: May 29, 2025

(54) OPTICAL COUPLER, PHOTOELECTRIC CONVERSION CIRCUIT MODULE, AND OPTICAL TRANSCEIVER

(71) Applicant: Murata Manufacturing Co., Ltd., Nagaokakyo-shi (JP)

(72) Inventors: Kazuki NAGASHIMA, Nagaokakyo-shi (JP); Yasuhiro SHIMIZU, Nagaokakyo-shi (JP); Masaki NAGATA, Nagaokakyo-shi (JP); Yuji MIURA, Nagaokakyo-shi (JP); Tatsuya TOMIMURA, Nagaokakyo-shi (JP); Naoya MORI, Nagaokakyo-shi (JP); Yutaka SENSHU, Nagaokakyo-shi (JP)

(21) Appl. No.: 19/037,452

(22) Filed: Jan. 27, 2025

Related U.S. Application Data
(63) Continuation of application No. PCT/JP2024/004310, filed on Feb. 8, 2024.

(30) Foreign Application Priority Data
Jul. 26, 2023 (JP) 2023-121575

(51) Int. Cl. G02B 6/42

(52) U.S. Cl. CPC G02B 6/4214; G02B 6/424

(57) ABSTRACT

An optical coupler including: an optical fiber fixing portion, a reflective portion that changes a traveling direction of light from a first to a second direction, and a holding portion that holds each of the optical fiber fixing portion and the reflective portion. The holding portion includes a first side wall portion, a second side wall portion, and a third side wall portion positioned on an opposite side of the second side wall portion along a third direction. Each of the optical fiber fixing portion and the reflective portion is connected to each of the second side wall portion and the third side wall portion. At least any one of a width of (1) the first side wall portion along the first direction, (2) the second side wall portion along the third direction, or (3) the third side wall portion along the third direction continuously increases toward the second direction.

### CROSS REFERENCE TO RELATED APPLICATIONS

The present application is a continuation of International application No. PCT/JP2024/004310, filed Feb. 8, 2024, which claims priority to Japanese Patent Application No. 2023-121575, filed Jul. 26, 2023, the entire contents of each of which are incorporated herein by reference.

### TECHNICAL FIELD

The present disclosure relates to an optical coupler, a photoelectric conversion circuit module, and an optical transceiver.

### BACKGROUND ART

A conventional optical coupler, such as for example, an optical module described in Patent Document 1 has been known. The optical module described in Patent Document 1 includes a package, a microlens, an optical fiber connector, a positioning unit, and a fixing unit. The package incorporates at least one of the light emitting element or the light receiving element. The microlens is fixed to the package so as to be positioned on an optical path of light emitted from the light emitting element and/or light incident on the light receiving element. The optical fiber connector includes an optical path changing portion that changes the direction of the optical path so that the light emitting element and/or the light receiving element and the optical fiber are optically coupled via the microlens. In addition, a V-shaped groove array for mounting an optical fiber is formed at the optical fiber connector. The positioning unit mechanically positions the package and the optical fiber connector so that the light emitting element and/or the light receiving element and the optical fiber are optically coupled via the microlens and the optical path changing portion. The fixing unit fixes the optical fiber connector to the package in a freely attachable and detachable manner.

Patent Document 1: Japanese Patent Application Laid-Open No. 2006-65358

### SUMMARY OF THE DISCLOSURE

In the optical module described in Patent Document 1, the microlens, the optical path changing portion, and the V-shaped groove array are different members, and are fixed by the fixing unit. Therefore, maintaining of positioning accuracy is difficult, and coupling efficiency between the light emitting element and/or the light receiving element, the microlens, the optical path changing portion, and the optical fiber may decrease.

In addition, the ambient light may enter from the outside of the optical module and be mixed in the light emitted from the optical fiber, so that the S/N ratio may decrease.

In view of the above, an object of the present disclosure is to provide an optical coupler, a photoelectric conversion circuit module, and an optical transceiver that can reduce a decrease in coupling efficiency and a decrease in the S/N ratio.

An optical coupler according to an aspect of the present disclosure comprises: an integrally molded body comprising a material containing glass and a filler mixed in the glass, the integrally molded body including: an optical fiber fixing portion constructed to fix each of a plurality of optical fibers that emit light in a first direction; a reflective portion constructed to change a traveling direction of the light emitted from any one of the plurality of optical fibers from the first direction to a second direction orthogonal to the first direction; and a holding portion constructed to hold each of the optical fiber fixing portion and the reflective portion, in which the holding portion includes: a first side wall portion extending in a third direction orthogonal to the first direction and the second direction; a second side wall portion connected to the first side wall portion and extending in the first direction; and a third side wall portion connected to the first side wall portion and extending in the first direction, the third side wall portion sandwiching the optical fiber fixing portion and the reflective portion and being positioned on an opposite side of the second side wall portion along the third direction as viewed in the second direction, wherein an end portion of each of the optical fiber fixing portion and the reflective portion along the third direction is connected to each of the second side wall portion and the third side wall portion, and at least any one of (1) a width of the first side wall portion along the first direction, (2) a width of the second side wall portion along the third direction, or (3) a width of the third side wall portion along the third direction continuously increases toward the second direction.

According to the optical coupler, the photoelectric conversion circuit module, and the optical transceiver according to the present disclosure, a decrease in coupling efficiency and a decrease in the S/N ratio can be reduced.

### BRIEF EXPLANATION OF THE DRAWINGS

FIG. 1 is a perspective view of an optical coupler 1.

FIG. 2 is a sectional view of the optical coupler 1 and an optical fiber 5.

FIG. 3 is a plan view of the optical coupler 1 as viewed in the opposite direction of a second direction DIR2.

FIG. 4 is a sectional view of the optical coupler 1 and the optical fiber 5, illustrating a state in which ambient light AL is incident on the optical coupler 1.

FIG. 5 is a sectional view of an optical coupler 1a and the optical fiber 5.

FIG. 6 is a sectional view of an optical coupler 1b and the optical fiber 5.

FIG. 7 is a plan view of an optical coupler 1c as viewed in the opposite direction of the second direction DIR2.

FIG. 8 is a perspective view of a photoelectric conversion circuit module 10 and the optical fibers 5.

FIG. 9 is a sectional view of the photoelectric conversion circuit module 10 and the optical fiber 5, taken along line A-A.

FIG. 10 is a perspective view of a photoelectric conversion circuit module 10a and the optical fibers 5.

FIG. 11 is a perspective view of an optical transceiver 100 and the optical fibers 5.

### DESCRIPTION OF THE PREFERRED EMBODIMENTS

### First Embodiment

### Structure of Optical Coupler 1

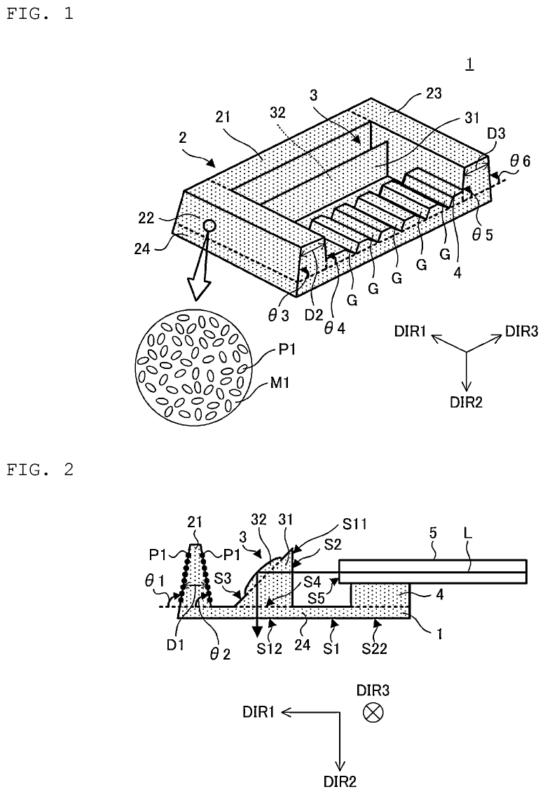

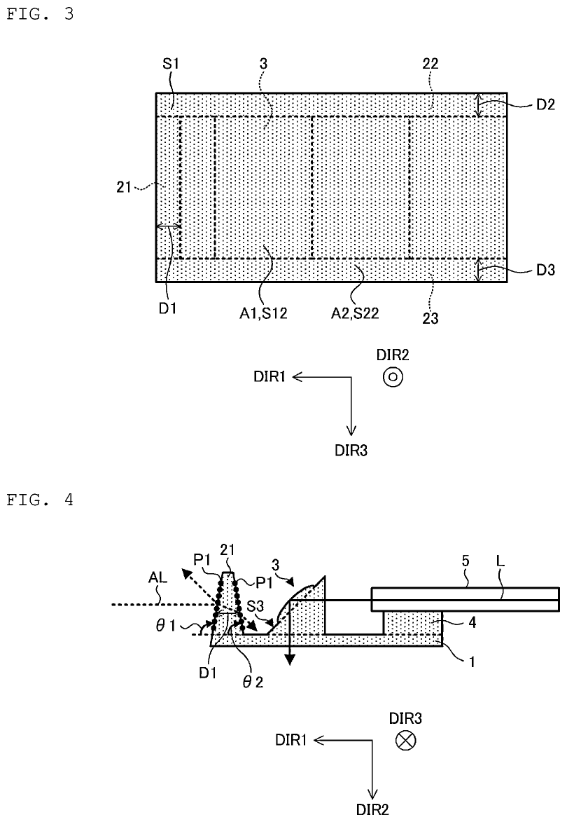

Hereinafter, an optical coupler 1 according to a first embodiment of the present disclosure will be described with reference to the drawings. FIG. 1 is a perspective view of the optical coupler 1. FIG. 2 is a sectional view of the optical coupler 1 and an optical fiber 5. In FIGS. 1 and 2, only representative fillers P1 among a plurality of the fillers P1 is denoted by a reference numeral. In FIG. 2, a second side wall portion 22 and a third side wall portion 23 are omitted. FIG. 3 is a plan view of the optical coupler 1 as viewed in the opposite direction of a second direction DIR2.

In the present specification, directions are defined as follows. As illustrated in FIG. 1, a direction in which an optical fiber fixing portion 4 and a reflective portion 3 are arranged in this order is defined as a first direction DIR1. A direction in which the reflective portion 3 and a bottom portion 24 are arranged in this order is defined as the second direction DIR2. A direction in which the second side wall portion 22 and the third side wall portion 23 are arranged in this order is defined as a third direction DIR3. The first direction DIR1, the second direction DIR2, and the third direction DIR3 are orthogonal to each other. Provided, however, that the first direction DIR1, the second direction DIR2, and the third direction DIR3 in the present specification are directions defined for convenience of description, and may not respectively coincide with the first direction DIR1, the second direction DIR2, and the third direction DIR3 at the time of use of the optical coupler 1.

The optical coupler 1 is a device for changing the traveling direction of light emitted from an optical fiber and emitting the light to a photoelectric conversion circuit or the like, or a device for changing the traveling direction of light emitted from the photoelectric conversion circuit or the like and emitting the light to the optical fiber. In the present embodiment, a case in which the optical coupler 1 changes the traveling direction of light L emitted from the optical fiber 5 from the first direction DIR1 to the second direction DIR2 will be described. As illustrated in FIG. 2, the optical coupler 1 has an incident surface S11 on which the light L emitted from the optical fiber 5 is incident and an emission surface S12 from which the light L is emitted in the second direction DIR2. Hereinafter, the structure of the optical coupler 1 will be described in detail.

As illustrated in FIG. 1, the optical coupler 1 includes a holding portion 2, the reflective portion 3, and the optical fiber fixing portion 4. The optical coupler 1 is integrally molded by using glass containing a filler. The optical coupler 1 is a single member. Here, the single member means a member having a structure that cannot be separated without being damaged. Therefore, for example, a member in which two resin pieces are fixed by a screw is not a single member.

The optical coupler 1 is integrally molded by using a material containing glass M1 and the plurality of fillers P1 mixed in the glass M1. Glass is a material that is amorphous and exhibits a glass transition phenomenon. Examples of the glass include glass of simple oxides such as SiO₂, B₂O₃, P₂O₅, GeO₂, and AS3O₃, glass of silicates such as Li₂O—SiO₂, Na₂O—SiO₂, and K₂O—SiO₂, glass of aluminosilicates such as Na₂O—Al₂O₃—SiO₂ and CaO—Al₂O₃—SiO₂, glass of borates such as Li₂O—B₂O₃ and Na₂O—B₂O₃, glass of aluminoborates such as CaO—Al₂O₃—B₂O₃, and glass of borosilicates such as Na₂O—Al₂O₃—B₂O₃—SiO₂.

The plurality of fillers P1 are metal oxide particles such as crystalline silica, amorphous silica, alumina, magnesium oxide, and titanium oxide. Each of the plurality of fillers P1 has a non-spherical shape. The plurality of fillers P1 are dispersed throughout the glass M1. Note that each of the plurality of fillers P1 may have a spherical shape. The plurality of fillers P1 may be uniformly dispersed throughout the glass M1, or may be non-uniformly dispersed throughout the glass M1.

The holding portion 2 holds each of the reflective portion 3 and the optical fiber fixing portion 4. The holding portion 2 is connected to each of the reflective portion 3 and the optical fiber fixing portion 4. The holding portion 2 includes a first side wall portion 21, the second side wall portion 22, the third side wall portion 23, and the bottom portion 24. Note that the holding portion 2 may not include the bottom portion 24.

The first side wall portion 21 is connected to each of the second side wall portion 22, the third side wall portion 23, and the bottom portion 24. More specifically, the first side wall portion 21 has a shape extending in the third direction DIR3. As illustrated in FIG. 2, in the present embodiment, an end surface of the first side wall portion 21 in the first direction DIR1 and an end surface of the first side wall portion 21 in the opposite direction of the first direction DIR1 (a first side surface and a second side surface arranged in the first direction DIR1) are inclined and form a tapered shape. More specifically, as viewed in the third direction DIR3, an angle θ1 formed by the first direction DIR1 and the end surface of the first side wall portion 21 in the first direction DIR1 is an obtuse angle. As viewed in the third direction DIR3, an angle θ2 formed by the first direction DIR1 and the end surface of the first side wall portion 21 in the opposite direction of the first direction DIR1 is an acute angle. Therefore, the end surface of the first side wall portion 21 in the first direction DIR1 and the end surface of the first side wall portion 21 in the opposite direction of the first direction DIR1 are not parallel to each other. A first width D1 of the first side wall portion 21 along the first direction DIR1 continuously increases toward the second direction DIR2. As illustrated in FIG. 1, an end surface of the first side wall portion 21 in the third direction DIR3 is connected to the third side wall portion 23. An end surface of the first side wall portion 21 in the opposite direction of the third direction DIR3 is connected to the second side wall portion 22. As illustrated in FIG. 2, an end surface of the first side wall portion 21 in the second direction DIR2 is connected to the bottom portion 24. In the present embodiment, the fillers P1 are exposed on the surface of the first side wall portion 21. Note that the end surface of the first side wall portion 21 in the first direction DIR1 and the end surface of the first side wall portion 21 in the opposite direction of the first direction DIR1 (the first side surface and the second side surface arranged in the first direction DIR1) may not be inclined and may not form a tapered shape. The fillers P1 may not be exposed on the surface of the first side wall portion 21.

As illustrated in FIG. 1, the second side wall portion 22 is connected to each of the first side wall portion 21, the bottom portion 24, the reflective portion 3, and the optical fiber fixing portion 4. More specifically, the second side wall portion 22 is positioned in the opposite direction of the third direction DIR3 with respect to the third side wall portion 23. The second side wall portion 22 has a shape extending in the first direction DIR1. In the present embodiment, an end surface of the second side wall portion 22 in the third direction DIR3 and an end surface of the second side wall portion 22 in the opposite direction of the third direction DIR3 (a third side surface and a fourth side surface arranged in the third direction DIR3) are inclined and form a tapered shape. More specifically, as viewed in the first direction DIR1, an angle 03 formed by the third direction DIR3 and the end surface of the second side wall portion 22 in the opposite direction of the third direction DIR3 is an acute angle. As viewed in the first direction DIR1, an angle 04 formed by the third direction DIR3 and the end surface of the second side wall portion 22 in the third direction DIR3 is an obtuse angle. The end surface of the second side wall portion 22 in the opposite direction of the third direction DIR3 and the end surface of the second side wall portion 22 in the third direction DIR3 are not parallel to each other. A second width D2 of the second side wall portion 22 along the third direction DIR3 continuously increases toward the second direction DIR2. A part of the end surface of the second side wall portion 22 in the third direction DIR3 is connected to each of the end surface of the first side wall portion 21 in the opposite direction of the third direction DIR3, the reflective portion 3, and the optical fiber fixing portion 4. An end surface of the second side wall portion 22 in the second direction DIR2 is connected to the bottom portion 24. In the present embodiment, the fillers P1 are exposed on the surface of the second side wall portion 22. Note that the end surface of the second side wall portion 22 in the third direction DIR3 and the end surface of the second side wall portion 22 in the opposite direction of the third direction DIR3 (the third side surface and the fourth side surface arranged in the third direction DIR3) may not be inclined and may not form a tapered shape. The fillers P1 may not be exposed on the surface of the second side wall portion 22.

The third side wall portion 23 is connected to each of the first side wall portion 21, the bottom portion 24, the reflective portion 3, and the optical fiber fixing portion 4. More specifically, the third side wall portion 23 is positioned in the third direction DIR3 with respect to the second side wall portion 22. As viewed in the second direction DIR2, the third side wall portion 23 is positioned on the opposite side of the second side wall portion 22 along the third direction DIR3 with the reflective portion 3 and the optical fiber fixing portion 4 interposed therebetween. The third side wall portion 23 has a shape extending in the first direction DIR1. In the present embodiment, an end surface of the third side wall portion 23 in the third direction DIR3 and an end surface of the third side wall portion 23 in the opposite direction of the third direction DIR3 (a third side surface and a fourth side surface arranged in the third direction DIR3) are inclined and form a tapered shape. More specifically, as viewed in the first direction DIR1, an angle θ5 formed by the third direction DIR3 and the end surface of the third side wall portion 23 in the opposite direction of the third direction DIR3 is an acute angle. As viewed in the first direction DIR1, an angle θ6 formed by the third direction DIR3 and the end surface of the third side wall portion 23 in the third direction DIR3 is an obtuse angle. Therefore, the end surface of the third side wall portion 23 in the third direction DIR3 and the end surface of the third side wall portion 23 in the opposite direction of the third direction DIR3 are not parallel to each other. A third width D3 of the third side wall portion 23 along the third direction DIR3 continuously increases toward the second direction DIR2. A part of the end surface of the third side wall portion 23 in the opposite direction of the third direction DIR3 is connected to each of the end surface of the first side wall portion 21 in the third direction DIR3, the reflective portion 3, and the optical fiber fixing portion 4. An end surface of the third side wall portion 23 in the second direction DIR2 is connected to the bottom portion 24. In the present embodiment, the fillers P1 are exposed on the surface of the third side wall portion 23. Note that the end surface of the third side wall portion 23 in the third direction DIR3 and the end surface of the third side wall portion 23 in the opposite direction of the third direction DIR3 (the third side surface and the fourth side surface arranged in the third direction DIR3) may not be inclined and may not form a tapered shape. The fillers P1 may not be exposed on the surface of the third side wall portion 23. It is sufficient that at least any one of the first width D1 of the first side wall portion 21, the second width D2 of the second side wall portion 22, or the third width D3 of the third side wall portion 23 be continuously increased toward the second direction DIR2.

Note that in the present embodiment, as illustrated in FIG. 3, the first width D1 of the first side wall portion 21, the second width D2 of the second side wall portion 22, and the third width D3 of the third side wall portion 23 are equal to each other at the same position in the second direction DIR2.

As illustrated in FIG. 1, the bottom portion 24 is connected to each of the first side wall portion 21, the second side wall portion 22, the third side wall portion 23, the reflective portion 3, and the optical fiber fixing portion 4. More specifically, the bottom portion 24 has a plate shape. In the present embodiment, the bottom portion 24 has a rectangular shape as viewed in the second direction DIR2. A part of the end surface of the bottom portion 24 in the opposite direction of the second direction DIR2 is connected to each of the end surface of the first side wall portion 21 in the second direction DIR2, the end surface of the second side wall portion 22 in the second direction DIR2, the end surface of the third side wall portion 23 in the second direction DIR2, the reflective portion 3, and the optical fiber fixing portion 4. Note that the bottom portion 24 may not have a rectangular shape as viewed in the second direction DIR2.

The optical fiber fixing portion 4 fixes each of the five optical fibers 5. The optical fiber fixing portion 4 is connected to each of the second side wall portion 22, the third side wall portion 23, and the bottom portion 24. More specifically, the optical fiber fixing portion 4 has a plate shape extending in the third direction DIR3. The optical fiber fixing portion 4 is positioned between the second side wall portion 22 and the third side wall portion 23. The optical fiber fixing portion 4 is connected to each of the second side wall portion 22 and the third side wall portion 23. More specifically, an end portion of the optical fiber fixing portion 4 along the opposite direction of the third direction DIR3 is connected to the second side wall portion 22. An end portion of the optical fiber fixing portion 4 along the third direction DIR3 is connected to each of the third side wall portion 23. An end surface of the optical fiber fixing portion 4 in the second direction DIR2 is connected to the bottom portion 24.

Five grooves G each having a V shape as viewed in the first direction DIR1 are provided on an end surface of the optical fiber fixing portion 4 in the opposite direction of the second direction DIR2. Each of the five grooves G has a shape extending in the first direction DIR1. The five grooves G are arranged in the third direction DIR3. As illustrated in FIG. 2, the five optical fibers 5 are respectively fixed to the five grooves G. In this way, the five optical fibers 5 are arranged in the third direction DIR3. Note that the groove G may not be provided on an end surface of the optical fiber fixing portion 4 in the opposite direction of the second direction DIR2. Each of the five grooves G may have a U shape as viewed in the first direction DIR1. The number of optical fibers 5 is not limited to five, and may be any number as long as it is more than one.

Each of the five optical fibers 5 has a shape extending in the first direction DIR1. Each of the five optical fibers 5 has an end surface S5 from which the light L is emitted. The normal direction of the end surface S5 in each of the five optical fibers 5 is the first direction DIR1. Each of the five optical fibers 5 emits the light L in the first direction DIR1. The end surface S5 of each of the five optical fibers 5 opposes the reflective portion 3 at an interval. The light L emitted from any one of the five optical fibers 5 travels in the first direction DIR1 and is incident on the reflective portion 3.

As illustrated in FIG. 1, the reflective portion 3 is connected to each of the second side wall portion 22, the third side wall portion 23, and the bottom portion 24. The reflective portion 3 is positioned between the second side wall portion 22 and the third side wall portion 23. The reflective portion 3 is connected to each of the second side wall portion 22 and the third side wall portion 23. More specifically, an end portion of the reflective portion 3 along the opposite direction of the third direction DIR3 is connected to the second side wall portion 22. An end portion of the reflective portion 3 along the third direction DIR3 is connected to the third side wall portion 23. As illustrated in FIG. 2, the reflective portion 3 changes the traveling direction of the light L incident from the incident surface S11 from the first direction DIR1 to the second direction DIR2. The reflective portion 3 includes a prism portion 31 and five condensing lens portions 32. Note that the number of condensing lens portions 32 is not limited to five, and may be any number as long as it is more than one.

The prism portion 31 is connected to each of the second side wall portion 22, the third side wall portion 23, and the bottom portion 24. More specifically, in the present embodiment, the prism portion 31 has a right-angled isosceles triangular prism shape extending in the third direction DIR3. The prism portion 31 includes a prism portion incident surface S2, a prism portion reflective surface S3, and a prism portion emission surface S4. The prism portion 31 may not have a right-angled isosceles triangular prism shape.

The prism portion incident surface S2 is an end surface of the prism portion 31 in the opposite direction of the first direction DIR1. The light L emitted from any one of the five optical fibers 5 is incident on the optical coupler 1 from the prism portion incident surface S2. Therefore, the prism portion incident surface S2 is the incident surface S11 of the optical coupler 1. The light L incident on the optical coupler 1 from the prism portion incident surface S2 passes through the inside of the prism portion 31.

The prism portion reflective surface S3 forms an angle of 135 degrees clockwise with respect to the first direction DIR1 as viewed in the third direction DIR3. An end of the prism portion reflective surface S3 in the opposite direction of the second direction DIR2 is positioned in the opposite direction of the first direction DIR1 with respect to an end of the prism portion reflective surface S3 in the second direction DIR2. The prism portion reflective surface S3 reflects the light L having passed through the inside of the prism portion 31. In this way, the prism portion reflective surface S3 changes the traveling direction of the light L from the first direction DIR1 to the second direction DIR2. Note that the prism portion reflective surface S3 corresponds to the “reflective surface” of the present disclosure.

The five condensing lens portions 32 are provided on the prism portion reflective surface S3. The five condensing lens portions 32 are arranged in the third direction DIR3. The surface of the condensing lens portion 32 has an aspherical shape. In the present embodiment, the surface of the condensing lens portion 32 has an elliptical spherical shape. The condensing lens portion 32 condenses the light L passing through the inside of the prism portion 31 and traveling in the first direction DIR1 and reflects the light L toward the second direction DIR2. In this way, the condensing lens portion 32 changes the traveling direction of the light L from the direction including the component of the first direction DIR1 to the second direction DIR2. Note that the surface of the condensing lens portion 32 may not have an elliptical spherical shape.

The prism portion emission surface S4 is an end surface of the prism portion 31 in the second direction DIR2. The prism portion emission surface S4 is connected to the bottom portion 24. The prism portion emission surface S4 emits the light L that has been reflected by the prism portion reflective surface S3 or the condensing lens portion 32 and has passed through the inside of the prism portion 31. The light L emitted from the prism portion emission surface S4 is incident on the bottom portion 24 from the end surface of the bottom portion 24 in the opposite direction of the second direction DIR2.

The light L incident on the bottom portion 24 from the end surface of the bottom portion 24 in the opposite direction of the second direction DIR2 passes through the inside of the bottom portion 24, and is emitted from an end surface S1 of the bottom portion 24 in the second direction DIR2 to the outside of the optical coupler 1. Therefore, the end surface S1 of the bottom portion 24 in the second direction DIR2 includes the emission surface S12 of the optical coupler 1.

Here, as illustrated in FIG. 3, in the end surface S1 of the bottom portion 24 in the second direction DIR2, a region overlapping the reflective portion 3 as viewed in the second direction DIR2 is defined as a region A1. In the end surface S1 of the bottom portion 24 in the second direction DIR2, a region not overlapping the reflective portion 3 as viewed in the second direction DIR2 is defined as a region A2. The end surface S1 of the bottom portion 24 in the second direction DIR2 includes both the region A1 and the region A2. The light L is emitted from the region A1 of the bottom portion 24 to the outside of the optical coupler 1. Therefore, the region A1 is the emission surface S12. The region A2 is a mounting surface S22 for mounting the optical coupler 1 on a substrate when the optical coupler 1 is incorporated in a later-described photoelectric conversion circuit module 10 or the like. The end surface S1 of the bottom portion 24 in the second direction DIR2 includes the emission surface S12 and the mounting surface S22. That is, the mounting surface S22 is in the same plane as the emission surface S12.

The optical coupler 1 is manufactured by irradiating a photosensitive glass paste containing the glass M1 and the plurality of fillers P1 mixed in the glass M1 with ultraviolet light and exposing the photosensitive glass paste. The photosensitive glass paste may contain additives such as a dispersant and a light absorber in addition to the glass M1 and the plurality of fillers P1 mixed in the glass M1.

More specifically, a light-transmissive substrate having a first main surface and a second main surface arranged in the second direction DIR2 is prepared. Next, a photosensitive glass paste is applied to the first main surface of the light-transmissive substrate. A mask is then disposed on the second main surface of the light-transmissive substrate. Subsequently, the second main surface of the light-transmissive substrate is irradiated with ultraviolet light to expose the photosensitive glass paste. In this way, the photosensitive glass paste reacts to light. Then, the mask is removed from the second main surface of the light-transmissive substrate, and the photosensitive glass paste is developed. More specifically, the photosensitive glass paste and the light-transmissive substrate are immersed in a developer solution. In this way, when the photosensitive glass paste is a negative-working paste, an exposed portion remains and an unexposed portion is removed in the photosensitive glass paste. Alternatively, when the photosensitive glass paste is a positive-working paste, an exposed portion is removed and an unexposed portion remains in the photosensitive glass paste. After the development, the photosensitive glass paste and the light-transmissive substrate are washed and dried.

Finally, the light-transmissive substrate is removed from the developed photosensitive glass paste, and the photosensitive glass paste is cured. More specifically, the photosensitive glass paste is fired to cure the photosensitive glass paste. The optical coupler 1 is completed through the above steps.

### Effects

According to the optical coupler 1, a decrease in coupling efficiency and a decrease in the S/N ratio can be reduced. First, description will be given of an ability of the optical coupler 1 to reduce a decrease in coupling efficiency.

The optical coupler 1 is integrally molded by using a material containing the glass M1 and the filler P1 mixed in the glass M1. Therefore, in the optical coupler 1, the components such as the microlens, the optical path changing portion, and the V-shaped groove array can always be disposed at the same position as compared with a case in which the components are different members. Therefore, positioning accuracy can be easily maintained, and a decrease in coupling efficiency can be reduced.

In addition, the optical coupler 1 includes the holding portion 2 including the first side wall portion 21, the second side wall portion 22 connected to the first side wall portion 21, and the third side wall portion 23. The third side wall portion 23 is connected to the first side wall portion 21 and positioned on the opposite side of the second side wall portion 22 along the third direction DIR3 with the reflective portion 3 and the optical fiber fixing portion 4 interposed therebetween as viewed in the second direction DIR2. For example, when the temperature of the optical coupler 1 rises due to heat generation of electronic components positioned around the optical coupler 1, the optical fiber fixing portion 4 and the reflective portion 3 is urged to deform due to thermal expansion. At this time, a force along the third direction DIR3 or the opposite direction of the third direction DIR3 is applied to the optical fiber fixing portion 4 and the reflective portion 3. In the optical coupler 1, each end portion of the optical fiber fixing portion 4 and the reflective portion 3 along the third direction DIR3 is connected to the third side wall portion 23. With this configuration, for example, when the optical fiber fixing portion 4 or the reflective portion 3 is urged to deform in the third direction DIR3 due to thermal expansion, the third side wall portion 23 inhibits deformation of the optical fiber fixing portion 4 or the reflective portion 3 in the third direction DIR3. Therefore, the optical fiber fixing portion 4 and the reflective portion 3 hardly deforms in the third direction DIR3.

In the optical coupler 1, each end portion of the optical fiber fixing portion 4 and the reflective portion 3 along the opposite direction of the third direction DIR3 is connected to the second side wall portion 22. With this configuration, for example, when the optical fiber fixing portion 4 or the reflective portion 3 is urged to deform in the opposite direction of the third direction DIR3 due to thermal expansion, the second side wall portion 22 inhibits deformation of the optical fiber fixing portion 4 or the reflective portion 3 in the opposite direction of the third direction DIR3. Therefore, the optical fiber fixing portion 4 and the reflective portion 3 hardly deforms in the opposite direction of the third direction DIR3. As a result, according to the optical coupler 1, the optical fiber fixing portion 4 and the reflective portion 3 can be prevented from deforming due to thermal expansion. By preventing the optical fiber fixing portion 4 and the reflective portion 3 from deforming due to thermal expansion, a change in a positional relationship between the optical fiber 5 and the reflective portion 3 and a decrease in coupling efficiency can be reduced.

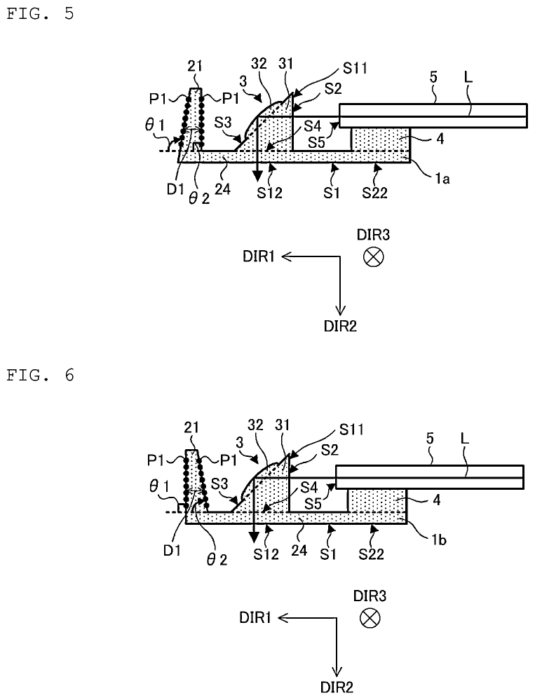

Next, description will be given of the ability of the optical coupler 1 to reduce a decrease in the S/N ratio with reference to the drawings. FIG. 4 is a sectional view of the optical coupler 1 and the optical fiber 5, illustrating a state in which ambient light AL is incident on the optical coupler 1. In FIG. 4, only representative fillers P1 among the plurality of fillers P1 is denoted by a reference numeral. Hereinafter, the first side wall portion 21 will be described as an example, but the same applies to the second side wall portion 22 and the third side wall portion 23.

For example, when the ambient light AL is incident on the first side wall portion 21 from the first direction DIR1, a part of the ambient light AL is reflected to the outside of the optical coupler 1 by the end surface of the first side wall portion 21 in the first direction DIR1. However, a part of the ambient light AL enters the inside of the first side wall portion 21 from the end surface of the first side wall portion 21 in the first direction DIR1. Here, the first width D1 of the first side wall portion 21 along the first direction DIR1 continuously increases toward the second direction DIR2. In the present embodiment, as viewed in the third direction DIR3, the angle θ1 formed by the first direction DIR1 and the end surface of the first side wall portion 21 in the first direction DIR1 is an obtuse angle. Therefore, the traveling direction of the ambient light AL entering the inside of the first side wall portion 21 is changed from a direction parallel to the first direction DIR1 to a direction including a component of the second direction DIR2 due to refraction by the end surface of the first side wall portion 21 in the first direction DIR1.

In the present embodiment, as viewed in the third direction DIR3, the angle 02 formed by the first direction DIR1 and the end surface of the first side wall portion 21 in the opposite direction of the first direction DIR1 is an acute angle. Therefore, the traveling direction of the ambient light AL traveling the inside of the first side wall portion 21 is changed so as to further approach the second direction DIR2 due to refraction by the end surface of the first side wall portion 21 in the opposite direction of the first direction DIR1. As described above, according to the optical coupler 1, the traveling direction of the ambient light AL is changed from the direction parallel to the first direction DIR1 to the direction including the component of the second direction DIR2. As a result, the ambient light AL can be prevented from being incident on the reflective portion 3. Thus, according to the optical coupler 1, mixing of the ambient light AL in the light L emitted from the optical fiber 5 can be reduced, and a decrease in the S/N ratio can be reduced. Consequently, according to the optical coupler 1, a decrease in the S/N ratio can be reduced.

As described above, according to the optical coupler 1, a decrease in coupling efficiency can be reduced and a decrease in the S/N ratio can be further reduced.

According to the optical coupler 1, a decrease in the S/N ratio can also be further reduced. Hereinafter, the first side wall portion 21 will be described as an example, but the same applies to the second side wall portion 22 and the third side wall portion 23.

In the first side wall portion 21, the fillers P1 are exposed on the surface of the first side wall portion 21. Therefore, the fillers P1 are exposed on the end surface of the first side wall portion 21 in the first direction DIR1 and the end surface of the first side wall portion 21 in the opposite direction of the first direction DIR1. The ambient light AL incident on the first side wall portion 21 from the first direction DIR1 is scattered by the fillers P1 exposed on the end surface of the first side wall portion 21 in the first direction DIR1. In this way, the intensity of the ambient light AL entering the inside of the first side wall portion 21 decreases. The ambient light AL travelling inside the first side wall portion 21 is scattered by the fillers P1 exposed on the end surface of the first side wall portion 21 in the opposite direction of the first direction DIR1. Therefore, the intensity of the ambient light AL incident on the reflective portion 3 from the end surface of the first side wall portion 21 in the opposite direction of the first direction DIR1 further decreases. Thus, according to the optical coupler 1, mixing of the ambient light AL in the light L emitted from the optical fiber 5 can be reduced, and a decrease in the S/N ratio can be further reduced.

As described above, according to the optical coupler 1, a decrease in coupling efficiency can be reduced and a decrease in the S/N ratio can be further reduced.

### First Modification

### Structure of Optical Coupler 1a

Hereinafter, an optical coupler 1a according to a first modification of the present disclosure will be described with reference to the drawings. FIG. 5 is a sectional view of the optical coupler 1a and the optical fiber 5. In FIG. 5, only representative fillers P1 among the plurality of fillers P1 is denoted by a reference numeral. In FIG. 5, the second side wall portion 22 and the third side wall portion 23 are omitted. Note that, for the structure of the optical coupler 1a according to the first modification, only portions different from those of the optical coupler 1 according to the first embodiment will be described, and the other portions will not be described.

In the present modification, the end surface of the first side wall portion 21 in the first direction DIR1 and the end surface of the first side wall portion 21 in the opposite direction of the first direction DIR1 (the first side surface and the second side surface arranged in the first direction DIR1) are not inclined and do not form a tapered shape. More specifically, as viewed in the third direction DIR3, the angle θ2 formed by the first direction DIR1 and the end surface of the first side wall portion 21 in the opposite direction of the first direction DIR1 is a right angle. On the other hand, as viewed in the third direction DIR3, the angle θ1 formed by the first direction DIR1 and the end surface of the first side wall portion 21 in the first direction DIR1 is an obtuse angle. Also in the present modification, similarly to the optical coupler 1, the first width D1 of the first side wall portion 21 continuously increases toward the second direction DIR2.

Note that the end surface of the second side wall portion 22 in the third direction DIR3 and the end surface of the second side wall portion 22 in the opposite direction of the third direction DIR3 (the third side surface and the fourth side surface arranged in the third direction DIR3) may not be inclined and may not form a tapered shape. More specifically, as viewed in the first direction DIR1, the angle θ4 formed by the third direction DIR3 and the end surface of the second side wall portion 22 in the third direction DIR3 may be a right angle. On the other hand, as viewed in the first direction DIR1, the angle θ3 formed by the third direction DIR3 and the end surface of the second side wall portion 22 in the opposite direction of the third direction DIR3 may be an acute angle. Also in this case, similarly to the optical coupler 1, the second width D2 of the second side wall portion 22 continuously increases toward the second direction DIR2.

Note that the end surface of the third side wall portion 23 in the third direction DIR3 and the end surface of the third side wall portion 23 in the opposite direction of the third direction DIR3 (the third side surface and the fourth side surface arranged in the third direction DIR3) may not be inclined and may not form a tapered shape. More specifically, as viewed in the first direction DIR1, the angle θ5 formed by the third direction DIR3 and the end surface of the third side wall portion 23 in the opposite direction of the third direction DIR3 may be a right angle. On the other hand, as viewed in the first direction DIR1, the angle θ6 formed by the third direction DIR3 and the end surface of the third side wall portion 23 in the third direction DIR3 may be an obtuse angle. Also in this case, similarly to the optical coupler 1, the third width D3 of the third side wall portion 23 continuously increases toward the second direction DIR2.

The optical coupler 1a as described above also has the same effect as the optical coupler 1.

### Second Modification

### Structure of Optical Coupler 1b

Hereinafter, an optical coupler 1b according to a second modification of the present disclosure will be described with reference to the drawings. FIG. 6 is a sectional view of the optical coupler 1b and the optical fiber 5. In FIG. 6, only representative fillers P1 among the plurality of fillers P1 is denoted by a reference numeral. In FIG. 6, the second side wall portion 22 and the third side wall portion 23 are omitted. Note that, for the structure of the optical coupler 1b according to the second modification, only portions different from those of the optical coupler 1 according to the first embodiment will be described, and the other portions will not be described.

In the present modification, the end surface of the first side wall portion 21 in the first direction DIR1 and the end surface of the first side wall portion 21 in the opposite direction of the first direction DIR1 (the first side surface and the second side surface arranged in the first direction DIR1) are not inclined and do not form a tapered shape. More specifically, as viewed in the third direction DIR3, the angle θ1 formed by the first direction DIR and the end surface of the first side wall portion 21 in the first direction DIR1 is a right angle. On the other hand, as viewed in the third direction DIR3, the angle θ2 formed by the first direction DIR1 and the end surface of the first side wall portion 21 in the opposite direction of the first direction DIR1 is an acute angle. Also in the present modification, similarly to the optical coupler 1, the first width D1 of the first side wall portion 21 continuously increases toward the second direction DIR2.

Note that the end surface of the second side wall portion 22 in the third direction DIR3 and the end surface of the second side wall portion 22 in the opposite direction of the third direction DIR3 (the third side surface and the fourth side surface arranged in the third direction DIR3) may not be inclined and may not form a tapered shape. More specifically, as viewed in the first direction DIR1, the angle θ3 formed by the third direction DIR3 and the end surface of the second side wall portion 22 in the opposite direction of the third direction DIR3 may be a right angle. On the other hand, as viewed in the first direction DIR1, the angle θ4 formed by the third direction DIR3 and the end surface of the second side wall portion 22 in the third direction DIR3 may be an obtuse angle. Also in this case, similarly to the optical coupler 1, the second width D2 of the second side wall portion 22 continuously increases toward the second direction DIR2.

Note that the end surface of the third side wall portion 23 in the third direction DIR3 and the end surface of the third side wall portion 23 in the opposite direction of the third direction DIR3 (the third side surface and the fourth side surface arranged in the third direction DIR3) may not be inclined and may not form a tapered shape. More specifically, as viewed in the first direction DIR1, the angle θ6 formed by the third direction DIR3 and the end surface of the third side wall portion 23 in the third direction DIR3 may be a right angle. On the other hand, as viewed in the first direction DIR1, the angle θ5 formed by the third direction DIR3 and the end surface of the third side wall portion 23 in the opposite direction of the third direction DIR3 may be an acute angle. Also in this case, similarly to the optical coupler 1, the third width D3 of the third side wall portion 23 continuously increases toward the second direction DIR2.

The optical coupler 1b as described above also has the same effect as the optical coupler 1.

### Third Modification

### Effect of Optical Coupler 1c

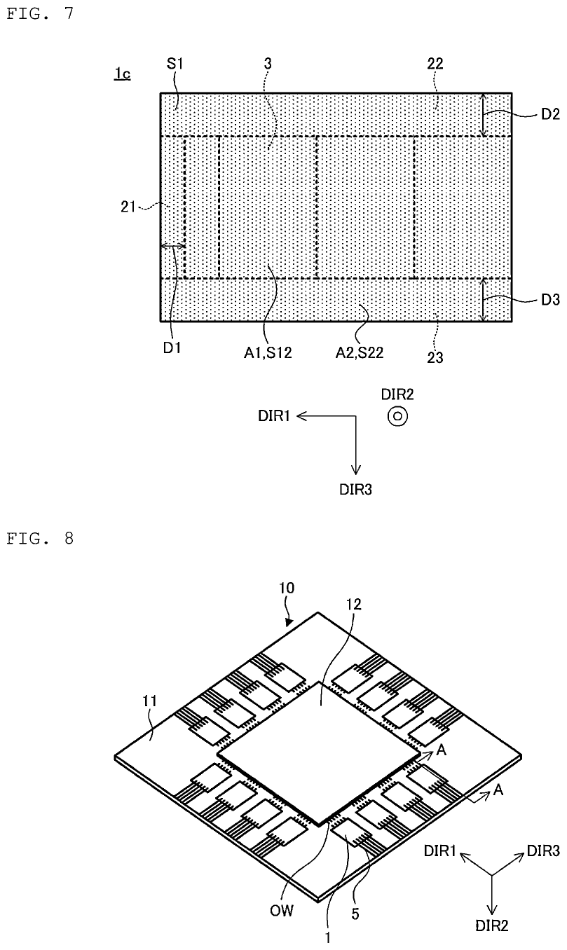

Hereinafter, an optical coupler 1c according to a third modification of the present disclosure will be described with reference to the drawings. FIG. 7 is a plan view of the optical coupler 1c as viewed in the opposite direction of the second direction DIR2. Note that, for the structure of the optical coupler 1c according to the third modification, only portions different from those of the optical coupler 1 according to the first embodiment will be described, and the other portions will not be described.

In the present modification, the second width D2 of the second side wall portion 22 is greater than the first width D1 of the first side wall portion 21 at the same position in the second direction DIR2. The third width D3 of the third side wall portion 23 is greater than the first width D1 of the first side wall portion 21. In the present modification, the second width D2 of the second side wall portion 22 is equal to the third width D3 of the third side wall portion 23 at the same position in the second direction DIR2. Note that the second width D2 of the second side wall portion 22 may not be equal to the third width D3 of the third side wall portion 23 at the same position in the second direction DIR2.

In other words, as viewed in the second direction DIR2, the longitudinal direction of the optical coupler 1c is the first direction DIR1. As viewed in the second direction DIR2, the short direction of the optical coupler 1c is the third direction DIR3. The longitudinal direction of the optical coupler 1c and the short direction of the optical coupler 1c are orthogonal to each other. At the same position in the second direction DIR2, the widths of the side wall portions each having a shape extending in the longitudinal direction (the first direction DIR1) of the optical coupler 1c (the second width D2 of the second side wall portion 22 and the third width D3 of the third side wall portion 23) is greater than the width of the side wall portion having a shape extending in the short direction (the third direction DIR3) of the optical coupler 1c (the first width D1 of the first side wall portion 21).

As viewed in the second direction DIR2, the longitudinal direction of the optical coupler 1c may be the third direction DIR3 and the short direction of the optical coupler 1c may be the first direction DIR1. In this case, it is sufficient that the width of the side wall portion having a shape extending in the longitudinal direction (the third direction DIR3) of the optical coupler 1c (the first width D1 of the first side wall portion 21) be greater than the widths of the side wall portions each having a shape extending in the short direction (the first direction DIR1) of the optical coupler 1c (the second width D2 of the second side wall portion 22 and the third width D3 of the third side wall portion 23), at the same position in the second direction DIR2.

The optical coupler 1c as described above also has the same effect as the optical coupler 1. According to the optical coupler 1c, a decrease in coupling efficiency can also be effectively reduced. Hereinafter, a case in which the longitudinal direction of the optical coupler 1c is the first direction DIR1 and the short direction of the optical coupler 1c is the third direction DIR3 as viewed in the second direction DIR2 will be described as an example. However, the same applies to a case in which the longitudinal direction of the optical coupler 1c is the third direction DIR3 and the short direction of the optical coupler 1c is the first direction DIR1 as viewed in the second direction DIR2.

When the side wall portion having the shape extending in the short direction of the optical coupler 1c deforms due to thermal expansion, the positional relationship between the optical fiber 5 and the reflective portion 3 further changes and the coupling efficiency further decreases as compared with the case in which the side wall portion having the shape extending in the longitudinal direction of the optical coupler 1c deforms due to thermal expansion.

In view of this, according to the optical coupler 1c, the second width D2 of the second side wall portion 22 is greater than the first width D1 of the first side wall portion 21 at the same position in the second direction DIR2. With this configuration, the rigidity of the second side wall portion 22 can be made higher than the rigidity of the first side wall portion 21. The third width D3 of the third side wall portion 23 is greater than the first width D1 of the first side wall portion 21. With this configuration, the rigidity of the third side wall portion 23 can be made higher than the rigidity of the first side wall portion 21. By increasing the rigidity of the third side wall portion 23 connected to the first side wall portion 21, the third side wall portion 23 having high rigidity can inhibit deformation of the first side wall portion 21 in the third direction DIR3 due to thermal expansion. In other words, the side wall portion having the shape extending in the longitudinal direction of the optical coupler 1c and having high rigidity can inhibit deformation of the optical coupler 1c in the short direction due to thermal expansion of the first side wall portion 21. Therefore, the first side wall portion 21 is less likely to deform in the short direction of the optical coupler 1c.

By increasing the rigidity of the second side wall portion 22 connected to the first side wall portion 21, the second side wall portion 22 having high rigidity can inhibit deformation of the first side wall portion 21 in the opposite direction of the third direction DIR3 due to thermal expansion. Therefore, the optical fiber fixing portion 4, the reflective portion 3, and the first side wall portion 21 are less likely to deform in the short direction of the optical coupler 1c.

As a result, according to the optical coupler 1c, the first side wall portion 21 can be effectively prevented from deforming due to thermal expansion. By preventing the first side wall portion 21 having a shape extending in the short direction of the optical coupler 1c from deforming due to thermal expansion, a change in a positional relationship between the optical fiber 5 and the reflective portion 3 can be reduced and a decrease in coupling efficiency can be effectively reduced.

### Fourth Modification

### Structure of Photoelectric Conversion Circuit Module 10

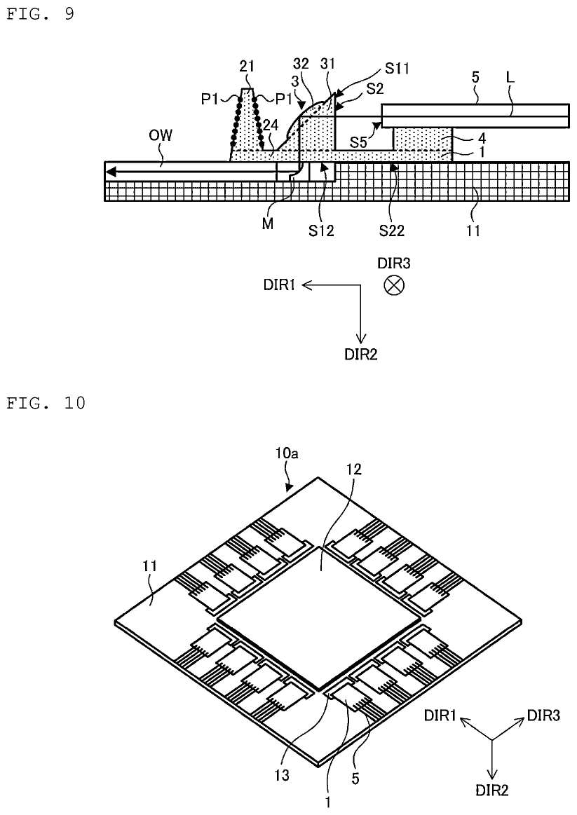

Hereinafter, a photoelectric conversion circuit module 10 according to a fourth modification will be described with reference to the drawings. FIG. 8 is a perspective view of the photoelectric conversion circuit module 10 and the optical fibers 5. In FIG. 8, only a representative optical coupler 1, optical fiber 5, and optical waveguide OW among the plurality of optical couplers 1, the plurality of optical fibers 5, and a plurality of the optical waveguides OW are denoted by reference numerals. FIG. 9 is a sectional view of the photoelectric conversion circuit module 10 and the optical fiber 5, taken along line A-A. In FIG. 9, only representative fillers P1 among the plurality of fillers P1 is denoted by a reference numeral.

As illustrated in FIG. 8, the photoelectric conversion circuit module 10 includes a plurality of the optical couplers 1, a substrate 11, and a photoelectric conversion circuit 12. The plurality of optical couplers 1 and the photoelectric conversion circuit 12 are mounted on the substrate 11. The photoelectric conversion circuit 12 is disposed at the center of the substrate 11 as viewed in the second direction DIR2. The plurality of optical couplers 1 are disposed around the photoelectric conversion circuit 12 as viewed in the second direction DIR2. Each of the plurality of optical fibers 5 is fixed to the respective one of the optical fiber fixing portions 4 of the plurality of optical couplers 1. Note that the number of optical couplers 1 is not limited to more than one, and may be one. The photoelectric conversion circuit 12 may not be disposed at the center of the substrate 11 as viewed in the second direction DIR2. The plurality of optical couplers 1 may not be disposed around the photoelectric conversion circuit 12 as viewed in the second direction DIR2. The photoelectric conversion circuit module 10 may include the optical coupler 1a, the optical coupler 1b, or the optical coupler 1c, instead of the optical coupler 1.

The substrate 11 has a plate shape having two main surfaces arranged in the second direction DIR2. However, as illustrated in FIG. 9, the optical waveguide OW and a mirror M are provided inside the substrate 11. The optical waveguide OW is provided between the photoelectric conversion circuit 12 and each of the plurality of optical couplers 1. The mirror M is provided in the second direction DIR2 with respect to the reflective portion 3. The light L emitted from the photoelectric conversion circuit 12 passes through the inside of the optical waveguide OW.

The plurality of optical couplers 1 are mounted on a main surface positioned in the opposite direction of the second direction DIR2 among the two main surfaces of the substrate 11. More specifically, the mounting surface S22 is mounted on the main surface positioned in the opposite direction of the second direction DIR2 among the two main surfaces of the substrate 11.

The photoelectric conversion circuit 12 is mounted on the main surface positioned in the opposite direction of the second direction DIR2 among the two main surfaces of the substrate 11. The photoelectric conversion circuit 12 converts the light emitted from the optical coupler 1 into an electrical signal or converts the electrical signal into light incident on the optical coupler 1. A case in which the photoelectric conversion circuit 12 converts the light emitted from the optical coupler 1 into an electrical signal will be described.

The light L emitted from any one of the five optical fibers 5 is incident on the incident surface S11 of the optical coupler 1, the traveling direction is changed from the first direction DIR1 to the second direction DIR2 by the optical coupler 1, and the light L is emitted from the emission surface S12 of the optical coupler 1. The light L emitted from the emission surface S12 of the optical coupler 1 travels in the optical waveguide OW in the second direction DIR2. The light L traveling in the optical waveguide OW in the second direction DIR2 is reflected by the mirror M. This changes the traveling direction of the light L from the second direction DIR2 to the first direction DIR1. Thereafter, the light L is incident on the photoelectric conversion circuit 12. The photoelectric conversion circuit 12 converts the light L incident on the photoelectric conversion circuit 12 into an electrical signal.

The photoelectric conversion circuit module 10 as described above also has the same effect as the optical coupler 1.

### Fifth Modification

### Structure of Photoelectric Conversion Circuit Module 10a

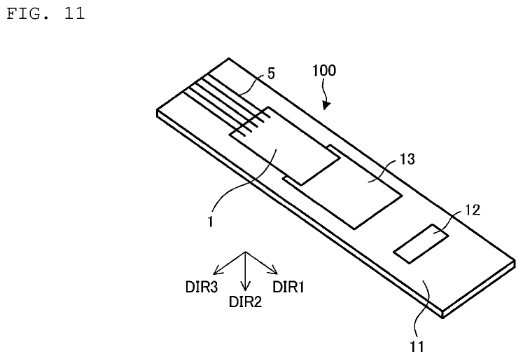

Hereinafter, a photoelectric conversion circuit module 10a according to a fifth modification will be described with reference to the drawings. FIG. 10 is a perspective view of the photoelectric conversion circuit module 10a and the optical fibers 5. In FIG. 10, only a representative optical coupler 1 and optical fiber 5 among the plurality of optical couplers 1 and the plurality of optical fibers 5 are denoted by reference numerals. Note that, for the photoelectric conversion circuit module 10a according to the fifth modification, only a portion different from those of the photoelectric conversion circuit module 10 according to the fourth modification will be described, and the other portions will not be described.

The photoelectric conversion circuit module 10a is different from the photoelectric conversion circuit module 10 in that the substrate 11 is a semiconductor substrate and the substrate 11 includes a plurality of light emitting portions 13. Note that the number of light emitting portions 13 is not limited to more than one, and may be one.

Each of the plurality of light emitting portions 13 is, for example, a surface emitting element formed on a main surface positioned in the opposite direction of the second direction DIR2 among the two main surfaces of the substrate 11. Each of the plurality of light emitting portions 13 is, for example, a vertical cavity surface emitting laser (VCSEL). Each of the plurality of light emitting portions 13 emits the light L on the basis of an electrical signal generated by the photoelectric conversion circuit 12. The light L emitted from each of the plurality of light emitting portions 13 is incident on each of respective ones of the plurality of optical fibers 5 via a respective one of the plurality of optical couplers 1.

The photoelectric conversion circuit module 10a as described above also has the same effect as the photoelectric conversion circuit module 10.

### Sixth Modification

### Structure of Optical Transceiver 100

Hereinafter, an optical transceiver 100 will be described with reference to the drawings. FIG. 11 is a perspective view of the optical transceiver 100 and the optical fibers 5. In FIG. 11, only a representative optical fiber 5 among the five optical fibers 5 are denoted by a reference numeral. Note that, for the optical transceiver 100 according to the sixth modification, only a portion different from those of the photoelectric conversion circuit module 10a according to the fifth modification will be described, and the other portions will not be described.

The optical transceiver 100 is different from the photoelectric conversion circuit module 10a in that the number of optical couplers 1 is one and the number of light emitting portions 13 is one.

The light L emitted from the light emitting portion 13 is incident on each of the five optical fibers 5 via the optical coupler 1, or the light L emitted from each of the five optical fibers 5 is incident on the photoelectric conversion circuit 12 via the optical coupler 1.

The optical transceiver 100 as described above also has the same effect as the photoelectric conversion circuit module 10a.

### Other Embodiments

The optical coupler according to the present disclosure is not limited to the optical coupler 1, the optical coupler 1a, the optical coupler 1b, or the optical coupler 1c, and can be changed within the scope of the gist thereof. In addition, the structures of the optical coupler 1, the optical coupler 1a, the optical coupler 1b, and the optical coupler 1c may be freely combined.

The photoelectric conversion circuit module according to the present disclosure is not limited to the photoelectric conversion circuit module 10 or the photoelectric conversion circuit module 10a, and can be changed within the scope of the gist thereof. In addition, the structures of the photoelectric conversion circuit module 10 and the photoelectric conversion circuit module 10a may be freely combined.

The optical transceiver according to the present disclosure is not limited to the optical transceiver 100, and can be changed within the scope of the gist thereof.

The present disclosure has the following configurations.
(1) An optical coupler being integrally molded by using a material containing glass and a filler mixed in the glass, the optical coupler including: an optical fiber fixing portion being configured to fix each of a plurality of optical fibers that emit light in a first direction; a reflective portion being configured to change a traveling direction of the light emitted from any one of the plurality of optical fibers from the first direction to a second direction orthogonal to the first direction; and a holding portion being configured to hold each of the optical fiber fixing portion and the reflective portion, in which the holding portion includes a first side wall portion having a shape extending in a third direction orthogonal to the first direction and the second direction, a second side wall portion being connected to the first side wall portion and having a shape extending in the first direction, and a third side wall portion being connected to the first side wall portion and having a shape extending in the first direction, the third side wall portion sandwiching the optical fiber fixing portion and the reflective portion and being positioned on an opposite side of the second side wall portion along the third direction as viewed in the second direction, an end portion of each of the optical fiber fixing portion and the reflective portion along the third direction is connected to each of the second side wall portion and the third side wall portion, and at least any one of a width of the first side wall portion along the first direction, a width of the second side wall portion along the third direction, or a width of the third side wall portion along the third direction continuously increases toward the second direction.
(2) The optical coupler according to (1), in which the filler is exposed on a surface of the first side wall portion, a surface of the second side wall portion, or a surface of the third side wall portion.
(3) The optical coupler according to (1) or (2), in which a first side surface and a second side surface of the first side wall portion that are arranged in the first direction are inclined and form a tapered shape, or a third side surface and a fourth side surface of the second side wall portion or the third side wall portion that are arranged in the third direction are inclined and form a tapered shape.
(4) The optical coupler according to any one of (1) to (3), in which the first direction is a longitudinal direction of the optical coupler as viewed in the second direction, the third direction is a short direction of the optical coupler as viewed in the second direction, and the width of the second side wall portion along the third direction and the width of the third side wall portion along the third direction are greater than the width of the first side wall portion along the first direction at the same position in the second direction.
(5) The optical coupler according to any one of (1) to (3), in which the third direction is a longitudinal direction of the optical coupler as viewed in the second direction, the first direction is a short direction of the optical coupler as viewed in the second direction, and the width of the first side wall portion along the first direction is greater than the width of the second side wall portion along the third direction and the width of the third side wall portion along the third direction at the same position in the second direction.

(6) A photoelectric conversion circuit module 1 including: the optical coupler according to any one of (1) to (5); a substrate; and a photoelectric conversion circuit being mounted on the substrate, in which the photoelectric conversion circuit converts an electrical signal into light incident on the optical coupler or converts light emitted from the optical coupler into an electrical signal.
(7) The photoelectric conversion circuit module according to (6), in which the substrate is a semiconductor substrate and includes a light emitting portion that emits light, and the optical coupler is mounted on the substrate.
(8) An optical transceiver including the optical coupler according to any one of (1) to (5).

### DESCRIPTION OF REFERENCE SYMBOLS

1, 1a, 1b, 1c: Optical coupler
2: Holding portion
3: Reflective portion
4: Optical fiber fixing portion
5: Optical fiber
10, 10a: Photoelectric conversion circuit module
11: Substrate
12: Photoelectric conversion circuit
13: Light emitting portion
21: First side wall portion
22: Second side wall portion
23: Third side wall portion
24: Bottom portion
31: Prism portion
32: Condensing lens portion
100: Optical transceiver
A1, A2: Region
AL: Ambient light
D1: First width
D2: Second width
D3: Third width
DIR1: First direction
DIR2: Second direction
DIR3: Third direction
G: Groove
L: Light
M: Mirror
M1: Glass
OW: Optical waveguide
P1: Filler
S1, S5: End surface
S11: Incident surface
S12: Emission surface
S2: Prism portion incident surface
S22: Mounting surface
S3: Prism portion reflective surface
S4: Prism portion emission surface

1. An optical coupler comprising:
an integrally molded body comprising a material containing glass and a filler mixed in the glass, the integrally molded body comprising:
an optical fiber fixing portion constructed to fix each of a plurality of optical fibers that emit light in a first direction;
a reflective portion constructed to change a traveling direction of the light emitted from any one of the plurality of optical fibers from the first direction to a second direction orthogonal to the first direction; and
a holding portion constructed to hold each of the optical fiber fixing portion and the reflective portion, wherein the holding portion includes:
a first side wall portion extending in a third direction orthogonal to the first direction and the second direction;
a second side wall portion connected to the first side wall portion and extending in the first direction; and
a third side wall portion connected to the first side wall portion and extending in the first direction, the third side wall portion sandwiching the optical fiber fixing portion and the reflective portion and positioned on an opposite side of the second side wall portion along the third direction as viewed in the second direction, wherein
an end portion of each of the optical fiber fixing portion and the reflective portion along the third direction is connected to each of the second side wall portion and the third side wall portion, and
at least any one of (1) a width of the first side wall portion along the first direction, (2) a width of the second side wall portion along the third direction, or (3) a width of the third side wall portion along the third direction continuously increases toward the second direction.

2. The optical coupler according to claim 1, wherein the filler is exposed on a surface of the first side wall portion, a surface of the second side wall portion, or a surface of the third side wall portion.

3. The optical coupler according to claim 1, wherein
a first side surface and a second side surface of the first side wall portion that are arranged in the first direction are inclined and form a tapered shape, or
a third side surface and a fourth side surface of the second side wall portion or the third side wall portion that are arranged in the third direction are inclined and form a tapered shape.

4. The optical coupler according to claim 3, wherein, as viewed in the third direction, a first angle formed by the first direction and the end surface of the first side wall portion in the first direction is an obtuse angle.

5. The optical coupler according to claim 4, wherein, as viewed in the third direction, a second angle formed by the first direction and the end surface of the first side wall portion in a direction opposite to the first direction is an acute angle.

6. The optical coupler according to claim 3, wherein, as viewed in the third direction, an angle formed by the first direction and the end surface of the first side wall portion in a direction opposite to the first direction is an acute angle.

7. The optical coupler according to claim 3, wherein, as viewed in the first direction, a first angle formed by the third direction and the end surface of the second side wall portion in a direction opposite to the third direction is an acute angle.

8. The optical coupler according to claim 7, wherein, as viewed in the first direction, a second angle formed by the third direction and the end surface of the second side wall portion in the third direction is an obtuse angle.

9. The optical coupler according to claim 3, wherein, as viewed in the first direction, an angle formed by the third direction and the end surface of the second side wall portion in the third direction is an obtuse angle.

10. The optical coupler according to claim 3, wherein, as viewed in the first direction, a first angle formed by the third direction and the end surface of the third side wall portion in a direction opposite to the third direction is an acute angle.

11. The optical coupler according to claim 10, wherein, as viewed in the first direction, a second angle formed by the third direction and the end surface of the third side wall portion in the third direction is an obtuse angle.

12. The optical coupler according to claim 3, wherein, as viewed in the first direction, an angle formed by the third direction and the end surface of the third side wall portion in the third direction is an obtuse angle.

13. The optical coupler according to claim 1, wherein
the first direction is a longitudinal direction of the optical coupler as viewed in the second direction,
the third direction is a short direction of the optical coupler as viewed in the second direction, and
the width of the second side wall portion along the third direction and the width of the third side wall portion along the third direction are greater than the width of the first side wall portion along the first direction at a same position in the second direction.

14. The optical coupler according to claim 1, wherein
the third direction is a longitudinal direction of the optical coupler as viewed in the second direction,
the first direction is a short direction of the optical coupler as viewed in the second direction, and
the width of the first side wall portion along the first direction is greater than the width of the second side wall portion along the third direction and the width of the third side wall portion along the third direction at a same position in the second direction.

15. The optical coupler according to claim 1, wherein the filler is a metal oxide particle.

16. The optical coupler according to claim 1, wherein the filler has a non-spherical shape.

17. The optical coupler according to claim 1, wherein the width of the first side wall portion along the first direction, the width of the second side wall portion along the third direction and the width of the third side wall portion along the third direction are equal to each other at a same position in the second direction.

18. A photoelectric conversion circuit module comprising:
the optical coupler according to claim 1;
a substrate; and
a photoelectric conversion circuit mounted on the substrate,
wherein the photoelectric conversion circuit converts an electrical signal into light incident on the optical coupler or converts light emitted from the optical coupler into an electrical signal.

19. The photoelectric conversion circuit module according to claim 18, wherein
the substrate is a semiconductor substrate and includes a light emitting portion that emits light, and
the optical coupler is mounted on the substrate.

20. An optical transceiver comprising the optical coupler according to claim 1.
